(19) United States
(12) Patent Application Publication
(10) Pub. No.: US 2006/0218012 A1
(43) Pub. Date: Sep. 28, 2006

(54) System for managing documents and associated document information deficiencies

(76) Inventors: Andres Hernandez, Downingtown, PA (US); William D. Lusen, East Norriton, PA (US); Frank W. Racis, Spring City, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/352,667

(22) Filed: Feb. 13, 2006

Related U.S. Application Data
(60) Provisional application No. 60/664,242, filed on Mar. 22, 2005.

(51) Int. Cl. G06F 17/00; G06F 19/00

(52) U.S. Cl. 705/3; 715/511

(57) ABSTRACT

A system auto-analyzes a document to automatically complete a record (e.g., a patient record) and create data indicating a document deficiency and assign data indicating the deficiency after the document is acquired into a patient record based on the type of the document and a predefined set of rules. A healthcare document processing system processes data indicating a document deficiency preventing a document from being designated complete. The system includes an interface for receiving data including a patient record identifier and data identifying a document, and an associated document type, the document having been added to a patient record having the patient record identifier. A document processor, in response to the received data, automatically: searches deficiency information associated with the patient record to identify a document deficiency associated with the document of the document type; indicates a deficiency associated with absence of the document from the patient record is corrected; and determines if a new deficiency is associated with the document and generates associated deficiency data identifying the new deficiency for incorporation in the deficiency information.

This is a non-provisional application of provisional application Ser. No. 60/664,242 by Andres Hernandez et al. filed Mar. 22, 2005.

### FIELD OF THE INVENTION

This invention concerns a system for identifying and managing document deficiencies and monitoring document or record completion to control workflow and automate a document completion process.

### BACKGROUND INFORMATION

Healthcare Information Management (HIM) departments in health care provider organizations are responsible for ensuring that patient records are complete and that a record contains required documents and that the documents are neither missing information nor contain inaccurate information. However, a HIM department does not have control over when a document is added to a record. A person reviewing a record is able to determine that the record is complete or not, based on the contents of the record at the time of the review. If a document is added to a record after it has been reviewed, it is possible that the record is no longer complete, and that it might need to be reviewed again.

Existing systems provide some automatic analysis of documents; however, these systems are limited and based on settings configured for a record having certain criteria. Existing systems using record criteria to process documents automatically can potentially miss documents that need to be analyzed if the documents are placed in a record that does not meet the criteria for records that need to be analyzed. A system according to invention principles addresses these deficiencies and related problems.

### SUMMARY OF THE INVENTION

A system auto-analyzes a document acquired into a record to, determine if the document is associated with identified existing document deficiencies, create data indicating a new deficiency as a result of acquiring the document into the record and if required, ensure that the record receives a further review by adding data to the record indicating a deficiency involving user review. A healthcare document processing system processes data indicating a document deficiency that prevents a document from being designated complete. The system includes an interface for receiving data including a patient record identifier and data identifying a document, and an associated document type, the document having been added to a patient record having the patient record identifier. A document processor, in response to the received data, automatically: searches deficiency information associated with the patient record to identify a document deficiency associated with the document of the document type; indicates a deficiency associated with absence of the document from the patient record is corrected; and determines if a new deficiency is associated with the document and generates associated deficiency data identifying the new deficiency for incorporation in the deficiency information.

### BRIEF DESCRIPTION OF THE DRAWING

FIG. 1 shows a document processing system involving document deficiency management, according to invention principles.

FIG. 2 shows a table illustrating two types of document deficiency having a common associated process type, according to invention principles.

FIG. 3 shows a user interface image menu used to create a document deficiency type in a healthcare Information Management system, according to invention principles.

FIG. 4 shows a user interface image window illustrating establishment of a document deficiency chain and its association with a document type, according to invention principles.

FIG. 5 shows a user interface image window illustrating creation of a document deficiency, according to invention principles.

FIG. 6 shows a flowchart of a process for auto-analyzing a document, according to invention principles.

FIG. 7 shows a user interface image window indicating a created document dictation deficiency, according to invention principles.

FIG. 8 shows a user interface image window indicating a created signature deficiency and absence of a document dictation deficiency, according to invention principles.

FIG. 9 shows a user interface image window indicating there are no deficiencies associated with a document, according to invention principles.

FIG. 10 shows a user interface image window illustrating automatic addition of a signature deficiency to a record, according to invention principles.

FIG. 11 shows a user interface image window illustrating a signature deficiency for a document not yet entered in the system, according to invention principles.

FIG. 12 shows a user interface image window illustrating application of a signature deficiency to an associated document upon acquisition of the associated document, according to invention principles.

FIG. 13 shows a user interface image window for editing a document deficiency type, according to invention principles.

FIG. 14 shows a user interface image window enabling creation of a document deficiency chain, according to invention principles.

FIG. 15 shows a flowchart of a process for processing a document involving document deficiency management, according to invention principles.

### DETAILED DESCRIPTION OF THE INVENTION

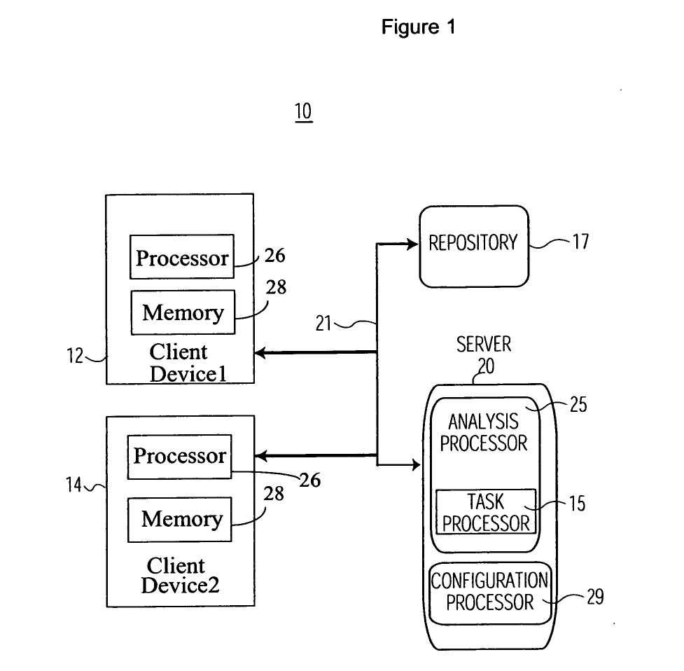

FIG. 1 shows a document processing system 10 involving document deficiency management. The system identifies document deficiencies, manages and chains document deficiency indicators together to support workflow control and automates a document completion process. In healthcare it is important to maintain documentation of good quality and this typically involves a review process to ensure that documentation is available and correct. Maintenance of documentation involves monitoring record completion and includes a task sequence workflow to collect documents that are relevant to individual health records and workflows (user or task performed task sequences) to validate that document information is correct and complete and not omitting vital data.

A record may comprise one or more documents and the term “record” may be used interchangeably with the term “document”. An executable application as used herein comprises code or machine readable instruction for implementing predetermined functions including those of an operating system, healthcare information system or other information processing system, for example, in response user command or input. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device. An object or data object as used herein comprises a grouping of data, executable instructions or a combination of both or an executable procedure. A document or record comprises a compilation of data in electronic form and is the equivalent of a paper document and may comprise a single, self-contained unit of information. It may consist of one or more “pages” of information bound together as a unit. The pages may be stored in any digital format as long as the stored pages can be rendered into a human readable presentation.

As used herein the term child refers to a folder or document that is contained within another folder. This term reflects the relationship of a folder or document with the folder in which it is contained. The term complete refers to a condition achieved by a folder or document when the information contained therein is verified to be accurate and whole. In the case of a document, this means when there is no missing information relevant and necessary to the document and the contained information is substantially accurate. A folder is complete when expected or required documents exist for that folder and documents contained in the folder are complete. A deficiency refers to some condition that makes a folder or document incomplete. For example, a folder may be missing an expected or required document or a document may be missing information or contain inaccurate information. A deficiency chain refers to an ordered series of data indicating deficiencies used to define a task sequence (a workflow) performed by a worker or system to control a record completion process. A deficiency chain comprises data indicating a sequence of deficiencies that needs to be addressed in order to ensure that a record or document is complete. A document type (an attribute of a document) is an identifier that is used to group together documents that have the same functional characteristics and allows the logical and physical grouping of documents based on their content. Document processing system 10 is configurable to perform particular actions based on document type. A Document identifier (document Id) is an internal identifier used to uniquely identify a single document in a document processing system.

A folder is a container used to organize documents. Folders can contain zero or more documents and zero or more subfolders. A folder may be considered a parent of documents and subfolders contained within it. The term incomplete is the antonym of complete. A parent refers to a folder in which another folder or document is contained. This term reflects the relationship of a folder to its contents. The term record is an equivalent term for folder and the two terms may be used interchangeably. Record completion refers to the process required to ensure that a folder or document is complete. A subfolder is a folder that is contained within another folder and is a child of another folder. The invention principles are applicable to any business object (i.e. an object in any industry such as an employee in the human resources industry or an account in the banking industry), but is described for exemplary purposes in the context of business objects of documents and records as defined below.

FIG. 1 shows document processing system 10 involving document deficiency management. Document processing system 10 includes client devices 12 and 14, repository 17 and server 20. Server 20 includes analysis processor 25 executing a document auto-analysis application and configuration processor 29 executing a configuration application. Analysis processor 29 includes task processor 15 executing a task processing (workflow) application. The system 10 devices are interconnected and bidirectionally communicate via network 21 such as a LAN (Local Area Network) or other type of network. A client device 12 or 14 includes processor 26 and memory unit 28 and may comprise a personal computer, for example. A user is able create, maintain and manage deficiency chain data using configuration processor 29 via one or more user interface images displayed on client device 12 or 14. The document processing system 10 may be used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

Repository 17 (representing one or more distributed repositories) includes chain data identifying, multiple document deficiencies, individual document deficiency type and an order for addressing the document deficiencies for providing completed documents. The document deficiency type and order for addressing the document deficiencies are used by task processor 15 to initiate a method of addressing a deficient condition. Task processor 15 executing a task processing application operating on server 20, uses repository 17 in automatically assigning tasks to be performed by one or more workers in the order for addressing the document deficiencies to correct the deficiencies. A record and the documents contained therein are considered potentially deficient until reviewed by qualified personnel for accuracy and completion. A record or document may be deficient because it is missing vital documents such as an operative report or discharge instructions, it is missing vital information or it contains incorrect information.

Analysis processor 25 provides document auto-analysis and automatically completes, creates or assigns deficiencies on documents in response to incorporation of a document into a patient record based on the type of the document and a predefined set of rules. Analysis processor 25 enables Healthcare Information Management (HIM) departments to automatically identify records that need to be reviewed again, and filters and excludes records that do not need to be reviewed as a result of inserting a document into a patient record. Analysis processor 25 ensures that documents of a given type are analyzed regardless of what record they are stored in and increases flexibility in a HIM department analyzing different types of documents. Analysis processor 25 uses configuration settings for a document type set by a user via display images on client device 12 or 14.

When a document is acquired into a patient record, system 10 automatically completes deficiencies in the record that were created as a result of the document not being in the record and applies remaining deficiencies in a deficiency chain if any, to the document that was just acquired. System 10 uses matching logic based on the type of document being acquired. For instance, if a patient record is deemed incomplete because of absence of a “medical history and physical” document, upon acquisition of a “medical history and physical” document, system 10 completes any applicable deficiencies in the record associated with absence of the “medical history and physical” document.

System 10 auto-analyzes documents based on document type. This enables a HIM department to configure a document completion function to perform different actions depending on the type of a given document. For instance, a “medical history and physical” document needs to be present in an inpatient medical record and also needs to be signed by an attending physician, while a “progress notes” document needs to be present in the record, but not signed. System 10 ensures that any “medical history and physical” document in the system gets signed. Deficiency types allow deficiencies to have a common set of characteristics based on the fact that they are of the same type. A deficiency type is composed of attributes including, Name, Description, Icon, Process Type and Age.

A Name attribute is indicative of what is deficient in a record. For instance “Waiting” indicates that the record is waiting for something in order to be complete. In this case the record is waiting for a document. A Description type attribute allows for a more complete description of what the deficiency type is supposed to indicate. For instance, “Waiting for missing document” is an appropriate description for a “Waiting” deficiency type. An Icon attribute is used to provide a visual clue to users of a HIM system that a deficiency of a given type is present by just glancing at the record. A Process Type attribute indicates deficiencies that need to be completed when a document is acquired into a record, or deficiencies that need to be applied to the document that has been acquired. One model process types is “Waiting for Document”, for example. An Age attribute indicates if a deficiency should age or not. This is used to indicate a user, responsible for completing a deficiency, has a given time duration to complete a deficiency. A combination of the above attributes indicates in system 10 how a deficiency that is present in a record or document is to be addressed.

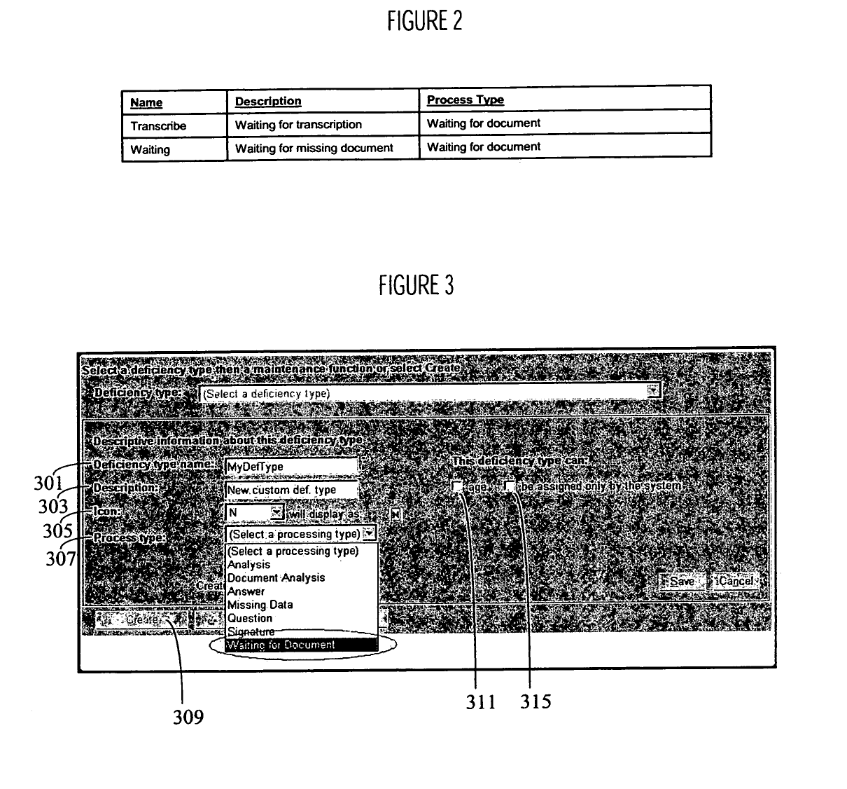

FIG. 2 shows a table illustrating two types of document deficiency having a common associated process type of “Waiting For Document”. Specifically, deficiency types “waiting for transcription” and “waiting for missing document” have the process type of “Waiting For Document”. FIG. 3 shows a user interface image menu used to create a deficiency type in a healthcare Information Management system. A user creates a new deficiency type by activation of button 309 upon selecting a new deficiency type in field 301, entry of an associated description in field 303, a related Icon in field 305 and a process type (set to “Waiting for document” in FIG. 3) in field 307. A user is also able to indicate the deficiency type is to age (indicating a user is responsible for completing a deficiency within a given time duration) or is assigned by the system, via checkboxes 311 and 315, respectively. Analysis processor 25 uses a process type to automatically complete a deficiency of the associated type.

Task processor 15 employs a method of addressing a deficient condition comprising an associated task sequence (a workflow) for performance by a system or worker or combination of both for eliminating the deficient condition. In response to task processor 15 addressing one document deficiency condition, a successive deficient condition may arise. In an example, a document may be missing from a medical record of a patient (a dictation deficiency) as indicated by deficiency chain data in repository 17. Task processor 15 in response to the deficiency chain data, automatically assigns a healthcare worker (e.g., a physician) the task of dictating the missing document. In response to dictation of the missing document, it needs to be transcribed into an electronic document (e.g., by being typed or scanned into a word processing application such as Microsoft Word®). Therefore, a transcription deficiency results from satisfying the dictation deficiency.

In response to deficiency chain data indicating a transcription deficiency, task processor 15 automatically assigns the task of transcribing the dictated document into an electronic document to a system or worker. In response to the transcription and associated deficiency chain data indicating an analysis deficiency, task processor 15 automatically assigns the task of analyzing an electronic version of the transcribed document to ensure that vital information is included. Similarly, in response to analysis of the electronic version of the transcribed document and associated deficiency chain data indicating a missing information deficiency, task processor 15 automatically assigns the task of incorporating the missing information in the electronic version of the transcribed document. Further, upon incorporation of the missing information and associated deficiency chain data indicating a review deficiency, task processor 15 automatically assigns the task of reviewing the electronic version of the transcribed document to a knowledgeable person to ensure document accuracy. Following satisfactory review of the transcribed document and in response to associated deficiency chain data indicating a signature deficiency, task processor 15 automatically assigns the task of signing the electronic version of the transcribed document to the reviewer. This task sequence may continue.

System 10 supports user selection of multiple sequencing options when defining deficiency chains for storage in repository 17. A deficiency that is created by a document auto-analysis process performed by analysis processor 25 is typically also part of a chain. A simple deficiency chain is a sequential chain in which each deficiency needs to be addressed before the next one may become active. Alternatively, a deficiency chain may define a fork in a process such that completing one deficiency activates several others concurrently thus creating a condition where multiple successive deficiencies are to be concurrently addressed. In some cases, concurrently addressed deficiencies may be interdependent and the completion of one deficiency negates the need to complete another, for example. In an example of a sequential document deficiency chain processed by task processor 15, a graphical representation of the chain uses an individual letter to indicate a type of deficiency that needs to be addressed in a predetermined order.
D→T→S

A “Dictate-Transcribe-Sign” deficiency chain is commonly used in Health Information Management. D indicates a dictation deficiency that identifies a required document does not exist and that a responsible worker needs to dictate the information to create the document. Dictation is usually performed using a voice recording mechanism and a worker indicates to system 10 that the dictation is done via data entry. In response to the dictation deficiency being addressed, the T (transcription) deficiency is activated indicating that the dictated document needs to be transcribed. Task processor 15 routes data indicating the deficiency to a transcriptionist (a worker responsible for doing the transcription) so a voice recording may be turned into an electronic document using a work processing application or some other means. The transcription deficiency is completed upon storage of the transcribed document. In response to storage of the transcribed document, the S (signature deficiency) is activated indicating that a worker needs to review the document for accuracy and sign the document thus testifying that the information is present and true. The T deficiency type has a process type of “Waiting for document”.
D: Is a deficiency of type “Dictate”
T: Is a deficiency of type “Transcribe”
S: Is a deficiency of type “Signature”

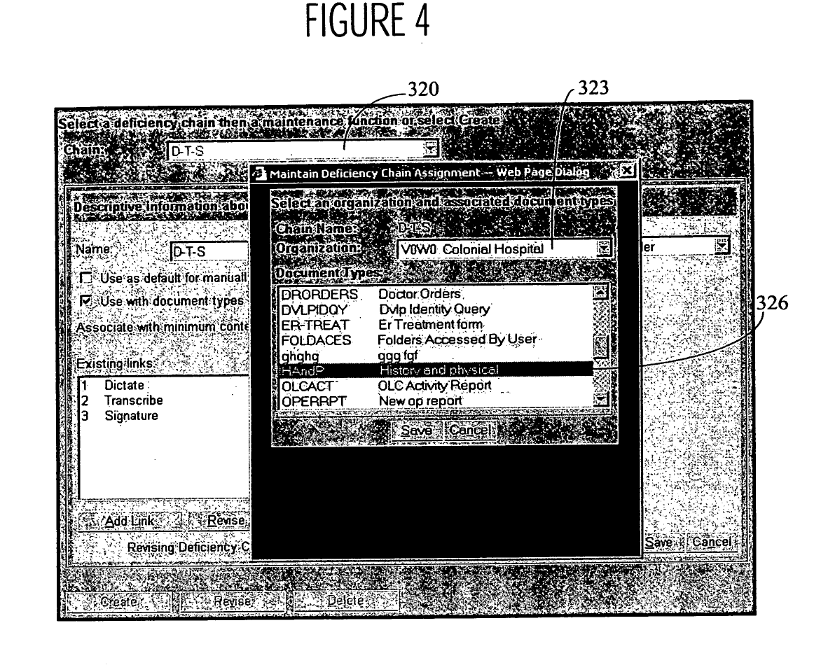

FIG. 4 shows a user interface image window illustrating establishment of a document deficiency chain and association of the chain with a document type. Specifically, the user interface image window shows an example of a “D-T-S” (Dictate-Transcribe-Sign) chain 320 being defined and “D-T-S” chain 320 being associated with a “HandP” (History and physical) document type 326 of organization 323. Upon determination that a document is not present in a patient medical record, a healthcare worker (or system 10) aware that the missing document type is typically dictated, is able to create deficiencies associated with the patient record by using the predefined “D-T-S” deficiency chain.

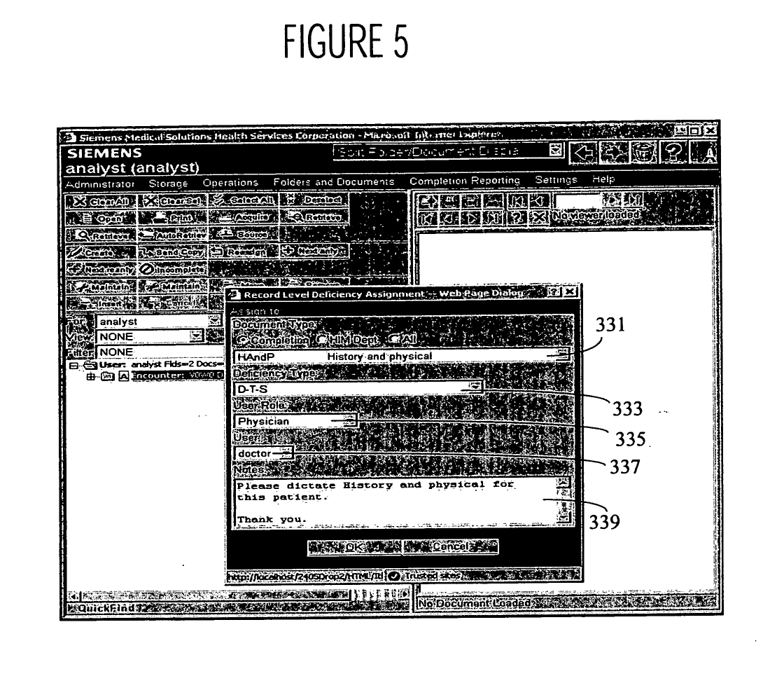

FIG. 5 shows a user interface image window illustrating creation of a deficiency. Upon determination that a HandP (history and physical) document type 331 is needed in a patient record, a healthcare worker associates the HandP document type 331 with a “D-T-S” chain 333 to indicate that the document needs to be dictated by a particular type of healthcare worker (here a doctor) 337 occupying a particular role (e.g., here a physician) 335, then transcribed and finally signed. The dictate instruction is entered in image area 339.

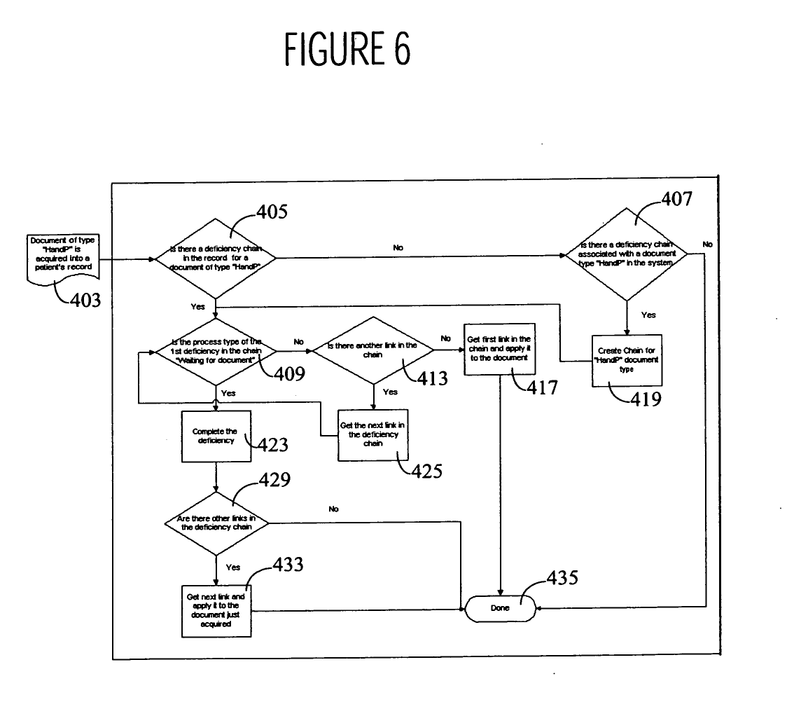

FIG. 6 shows a flowchart of a process for auto-analyzing a document performed by analysis processor 25, including task processor 15 (FIG. 1). A user reviewing a patient record may determine that a document of a given type is not present in the record. For instance, if a patient is in hospital for surgery, a “history and physical” document needs to be present in the patient record. In addition, a user reviewing the record may also determine that once added to the record, the document needs to be signed by the author. These requirements may be indicated by entry of a deficiency chain of one or more deficiencies to the record. When the “missing” document is inserted into the patient's electronic record, the “Document auto-analysis” process matches the type of document acquired into the record with the existing deficiency in the record and completes any applicable deficiencies related to that document.

In the document auto-analysis process of FIG. 6, following review of a record, the record is released to users that need to perform actions to complete the record. If a document is inserted into the record after it has been released by the reviewer (often known as “loose sheet processing”), the document auto-analysis process ensures that the record is complete and accurate and if needed it advantageously ensures that the record gets reviewed again. This is done by matching the type of document that was acquired into the record with information stored in the repository 17 indicating a document of a given type needs to have some actions performed and needs to be reviewed to ensure that the document is complete.

Processor 25 in step 403 detects a HandP document is acquired and incorporated in a particular patient record in repository 17 and in step 405 determines whether there is a deficiency chain associated with both the acquired HandP document and the particular patient record. If a deficiency chain is associated with both the acquired HandP document and the particular patient record, processor 25 in step 409 determines whether a Process Type associated with the first deficiency in the deficiency chain is a “Waiting for document” type. If the Process Type is a “Waiting for document” type, processor 25 completes the deficiency in step 423. Further, processor 25 in step 429 determines if there are other deficiencies in the deficiency chain (indicating one or more further tasks) and if there is another deficiency, processor 25 in step 433 gets the next deficiency in the deficiency chain and performs an associated task for the acquired document and the process ends -at step. 435. If processor 25 in step 429 determines there are no other deficiencies in the deficiency chain, the process ends at step 435

If processor 25 in step 409 determines that no “Waiting for document” Process Type is associated with the first deficiency in the deficiency chain, processor 25 determines in step 413 if there is a further deficiency in the deficiency chain. If it is determined in step 413 there is no further deficiency in the deficiency chain, processor 25 in step 417 gets the first deficiency in the deficiency chain and performs an associated task for the acquired document and the process ends at step 435. If it is determined in step 413 there is a further deficiency in the deficiency chain, processor 25 in step 417 gets the next deficiency in the deficiency chain and continues the process at step 409.

In step 405, if processor 25 determines there is no deficiency chain associated with both the acquired HandP document and the particular patient record, processor 25 determines in step 407 if there is a deficiency chain associated with the acquired HandP document type in system 10 (e.g., in repository 17). If there is a deficiency chain associated with the acquired HandP document type, processor 25 creates a deficiency chain for the acquired HandP document and the particular patient record in step 419 and continues the process from step 409. Further, if processor 25 determines in step 407 there is no deficiency chain associated with the acquired HandP document type in system 10, the process ends at step 435.

When a document is acquired into a HIM application, processor 25 employs the FIG. 6 document auto-analysis process in completing existing deficiencies, creating and completing deficiencies, or applying existing deficiencies to a document that is acquired. Processor 25 provides the document auto-analysis process with information related to the document that has been acquired including document type, document id, and information related to the patient record where the document was acquired such as the encounter number and patient admission date, for example. The document auto-analysis process employs the provided document related information in searching a HIM database (repository 17) for existing deficiencies of a particular patient record that matches the document type of the document that was acquired. For example, a “D-T-S” chain is created for a particular patient record for a document type of HandP.

Processor 25 employs the FIG. 6 document auto-analysis process (step 405) to find a deficiency match for a “Dictation” deficiency because it is in the particular patient record where the document is filed and because it is associated with a HandP document type. In response to a match being found, the document auto-analysis process navigates through the deficiency chain (in steps 409, 413 and 425 of FIG. 6) until it finds a deficiency with a process type of “Waiting for document”. The Document auto-analysis process completes those deficiencies in the chain up to and including the one that has a “Waiting for Document” process type (in step 423 of FIG. 6). In the “D-T-S” deficiency chain, the Dictate (D) and Transcribe (T) deficiencies are completed. The presence of the acquired document in the particular patient record indicates that the document no longer needs to be dictated or transcribed. The Signature (S) deficiency is applied to the newly acquired document (in step 433 via step 429 of FIG. 6) because the “Transcribe” model deficiency has a process type of “Waiting for document”.

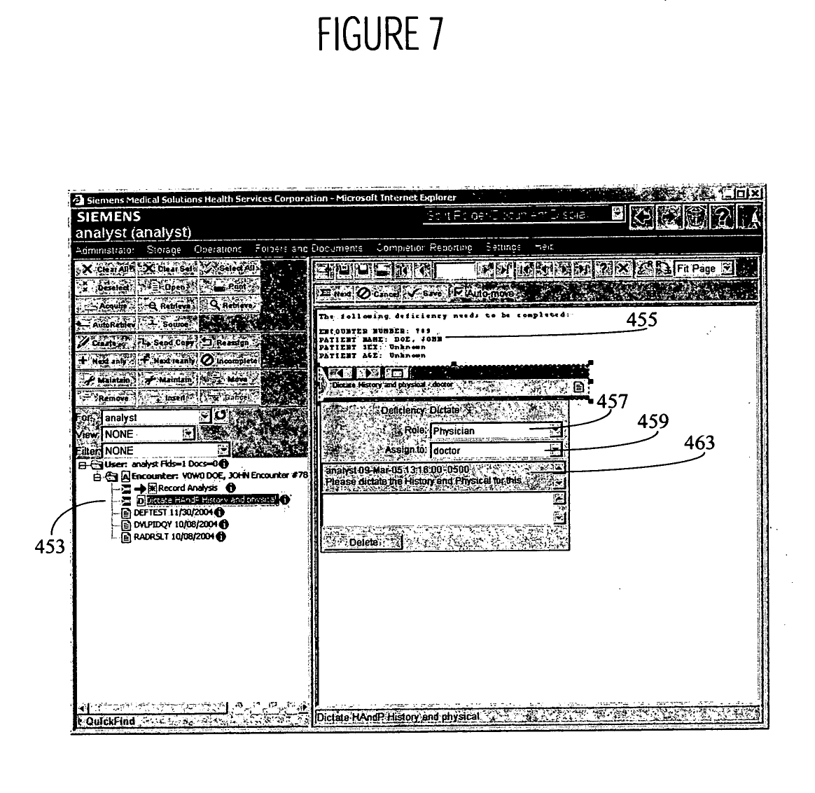

FIG. 7 shows a user interface image window indicating a created document dictation deficiency. The image window indicates that a user reviewing a patient record made a decision indicating that a HandP document needs to be dictated by placing a “dictate” deficiency 453 on the medical record of a particular patient 455. The user creates the deficiency by indicating, using message 463, that a HandP document needs to be dictated by a healthcare worker (a doctor 459) performing a particular role (a physician role 457).

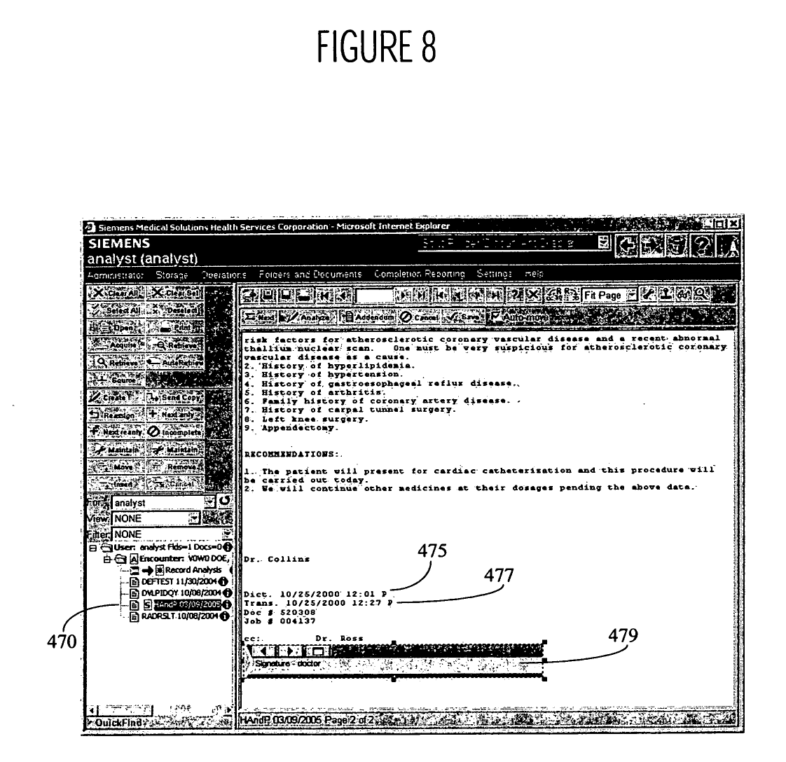

FIG. 8 shows a user interface image window indicating a created signature deficiency and absence of a document dictation deficiency. The user interface image shows that a dictation deficiency is no longer in the record, but instead there is a signature deficiency 470 that is applied to the HandP document. Processor 25 applies the FIG. 6 document auto-analysis process in automatically completing the “Dictate” and “Transcription” deficiencies as indicated in items 475 and 477 and applying the “Signature” deficiency 470 to the document that is acquired into the patient record. Message 479 indicates to a doctor that the HandP document needs to be signed.

A document deficiency creation and completion function in the document auto-analysis process of FIG. 6 is employed by processor 25 when a document is acquired into a patient record and processor 25 fails to find any existing deficiencies in a HIM database (repository 17) that match the document type of the acquired document. In the absence of existing matching deficiencies, processor 25 using the document auto-analysis process, determines (in step 407 of FIG. 6) if there are any deficiency chains associated with the type of document that is acquired. In the example, a “D-T-S” chain is associated with the HandP document type as illustrated in FIG. 4. As a document that is associated with a deficiency chain is being acquired, the Document auto-analysis process automatically creates (in step 419 of FIG. 6) the deficiencies defined in the “D-T-S” chain. Processor 25 completes them as previously described in connection with FIG. 6. If the record has already been reviewed, the record is reviewed again as a result of adding a new document in the record. If necessary, the Document auto-analysis process advantageously creates a new deficiency indicating to a Healthcare Information Management department that the record gets a further review.

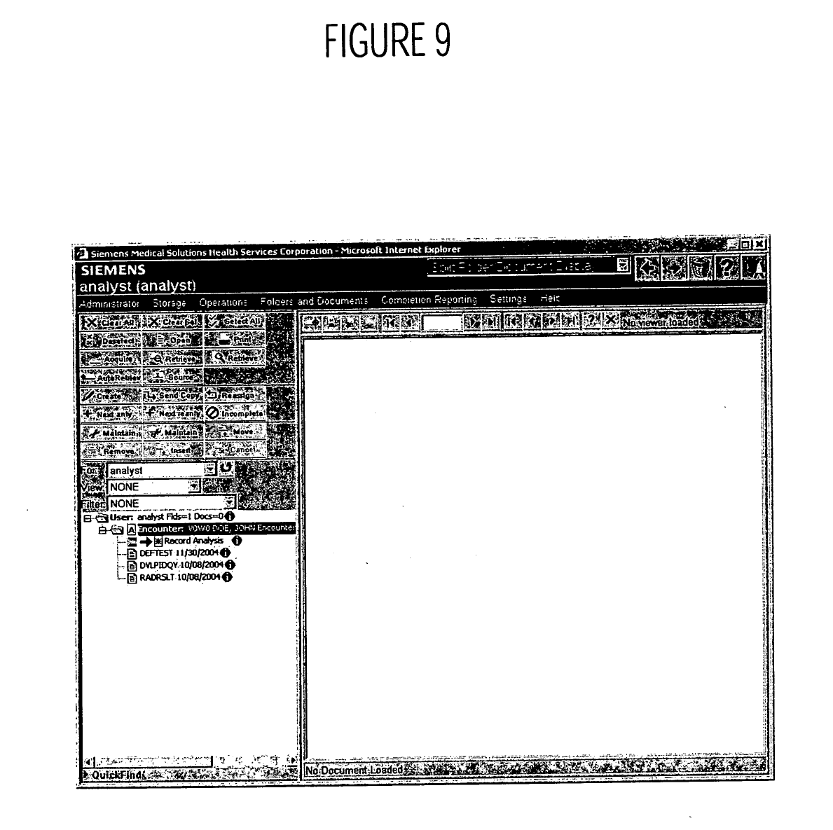

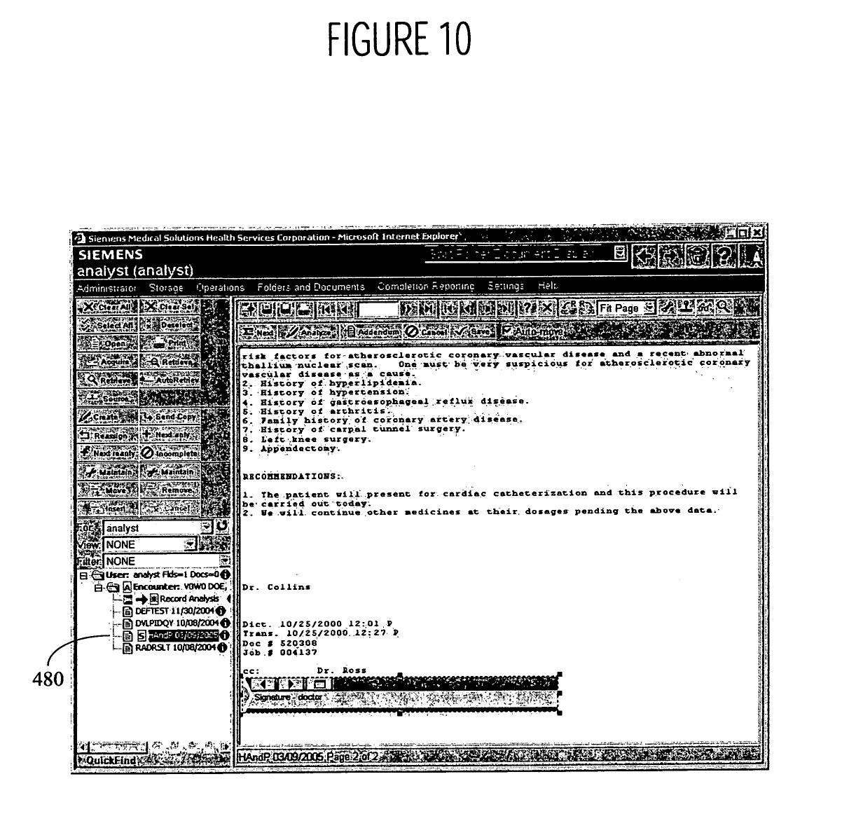

FIG. 9 shows a user interface image window indicating there are no deficiencies associated with a HandP document. FIG. 10 shows a user interface image window illustrating automatic addition of a signature deficiency to a record. In response to acquiring a document of type HandP into a patient record, processor 25 employs the FIG. 6 document auto-analysis process in automatically adding “signature” deficiency 480 to a patient record. Processor 25 automatically adds the signature deficiency because the “D-T-S” chain is associated with the HandP document type.

The document auto-analysis process employed by processor 25 applies existing deficiencies in a HIM database (repository 17) to a document that is incorporated into a patient medical record. The document auto-analysis process finds an existing deficiency that matches a document type of a document incorporated into a patient record (step 405 of FIG. 6) and navigates through a deficiency chain to see if there are any deficiencies with a process type of “Waiting for document” (steps 409, 413 and 425 of FIG. 6). If none are found, the document auto-analysis process applies the first link of the chain to the document that was just acquired (step 417 of FIG. 6). Upon a user reviewing a patient record and determining that a “History and Physical” (HandP) document that is not currently present in the record needs to be signed, the user assigns a “signature” deficiency to the record. Once the document is acquired into the record, the “signature” deficiency is applied to the document.

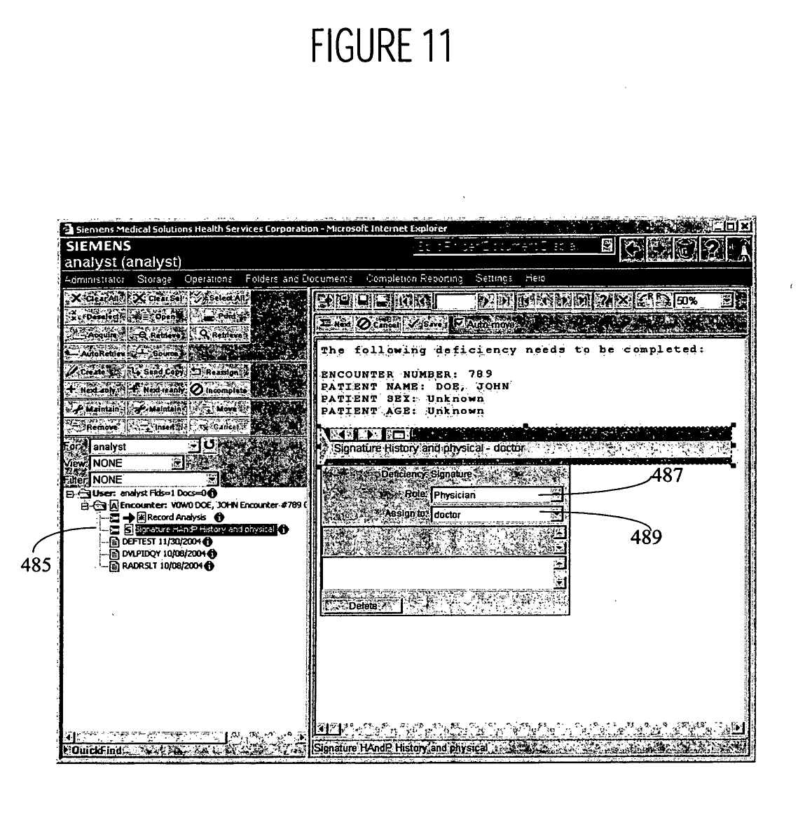

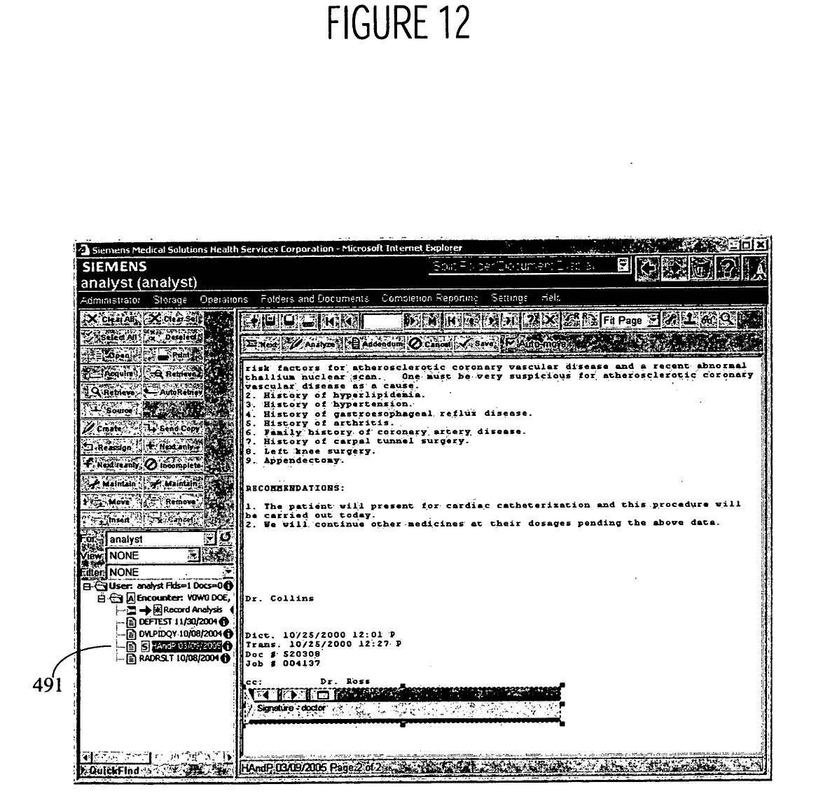

FIG. 11 shows a user interface image window illustrating a signature deficiency 485 for a document not yet entered in the system. The HandP document needs to be signed by a healthcare worker (a doctor 489) performing a particular role (a physician role 487). FIG. 12 shows a user interface image window illustrating application of a signature deficiency to an associated document upon acquisition of the associated document. Specifically, upon incorporation of a HandP document into a patient record, a “signature” deficiency 491 is applied to the HandP document.

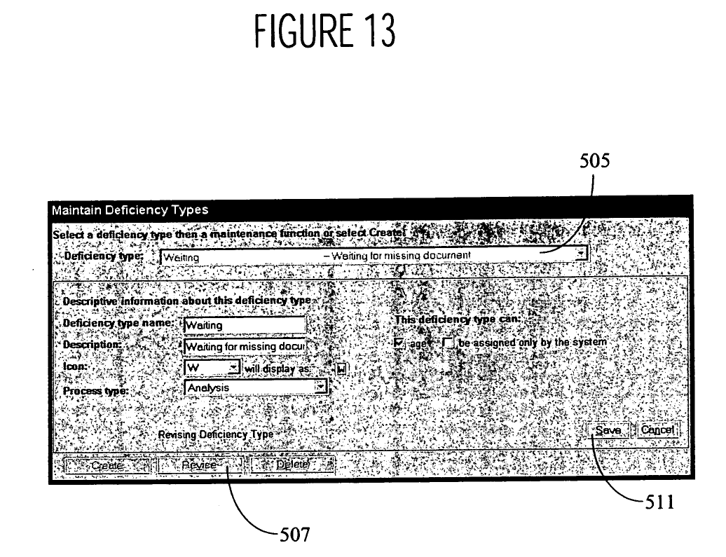

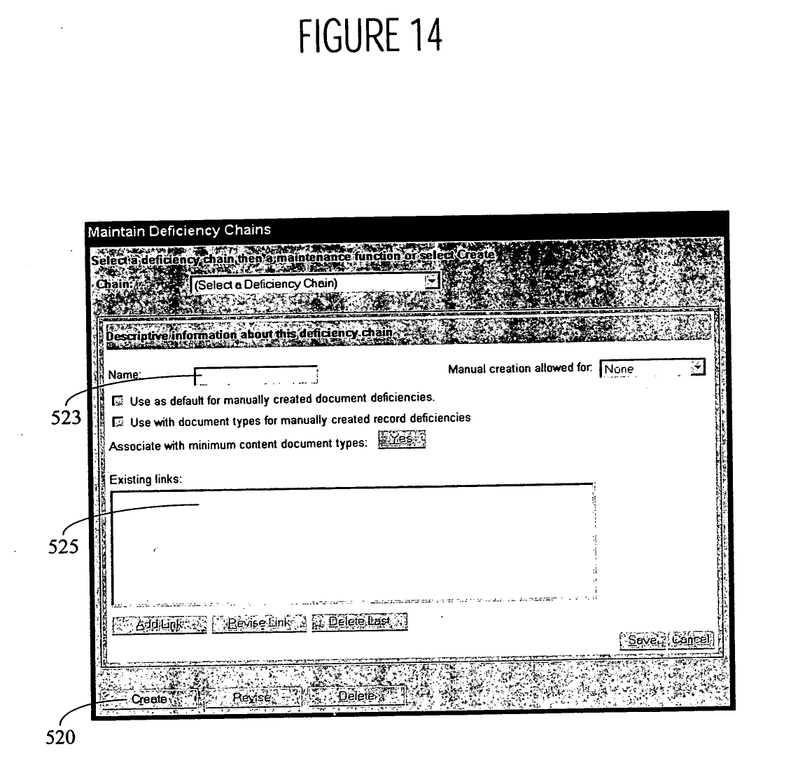

FIG. 13 shows a user interface image window for editing a deficiency type. A user selects a deficiency type from dropdown list 505 and clicks revise button 507 and edits the fields as desired. Upon completion, a user clicks save button 511. FIG. 14 shows a user interface image window enabling creation of a document deficiency chain. In response to a user clicking create button 520, data entry fields become active for editing, enabling a user to enter a deficiency chain name 523 and deficiency chain links in image area 525.

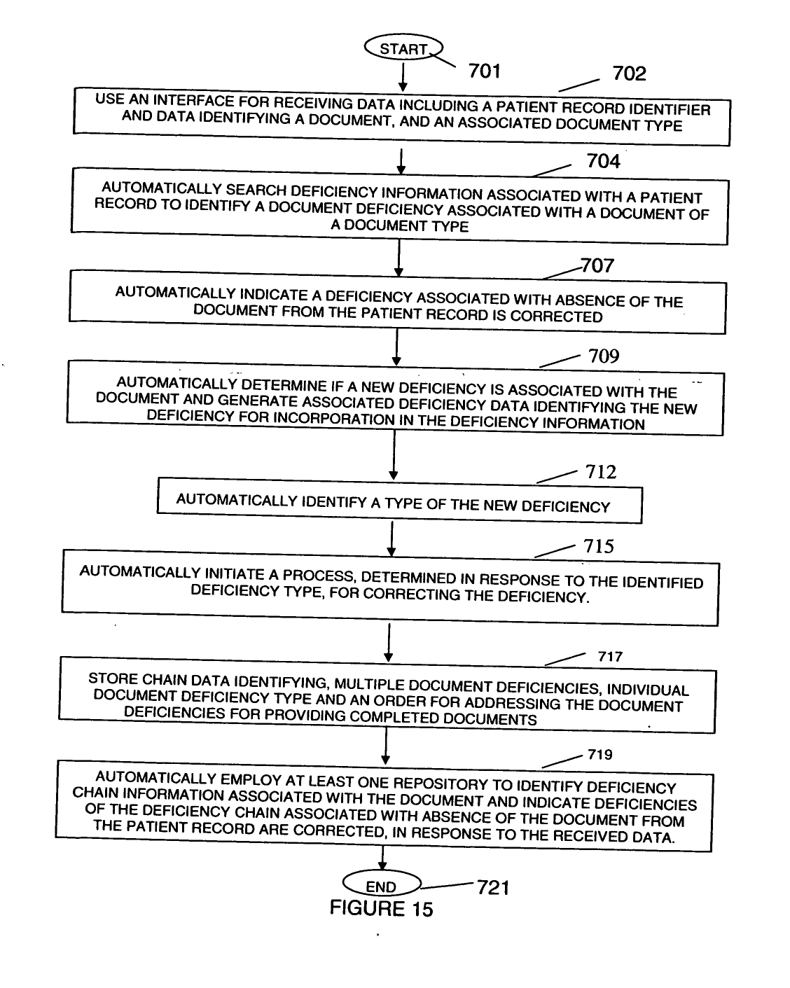

FIG. 15 shows a flowchart of a process performed by processor 25 (FIG. 1) for processing data indicating a document deficiency. In step 702 following the start at step 701, processor 25 employs an interface for receiving data including a patient record identifier and data identifying a document, and an associated document type, the document having been added to a patient record having the patient record identifier. Processor 25 (including a document processor) in step 704 automatically searches deficiency information associated with the patient record to identify a document deficiency associated with the document of the document type, in response to the received data. Processor 25 in step 707 automatically indicates a deficiency associated with absence of the document from the patient record is corrected and determines in step 709 if a new deficiency is associated with the document and generates associated deficiency data identifying the new deficiency for incorporation in the deficiency information, in response to the received data.

In step 712, processor 25 automatically identifies a type of the new deficiency indicating how a deficiency is to be corrected and the purpose of the deficiency and in step 715 initiates a process, determined in response to the identified deficiency type, for correcting the deficiency. Processor 25 also initiates generation of an alert message to a user indicating user attention is required. A task processor in processor 25 automatically assigns a task to be performed by a healthcare worker in response to the determined new deficiency. Processor 25 in step 717, stores chain data in repository 17 (at least one repository) identifying, multiple document deficiencies, individual document deficiency type and an order for addressing the document deficiencies for providing completed documents. Repository 17 associates a document type with an individual deficiency type and with a process to be used in correcting the individual deficiency.

In step 719, processor 25 automatically employs the at least one repository to identify deficiency chain information (e.g., comprising data objects) associated with the document and indicate deficiencies of the deficiency chain associated with absence of the document from the patient record are corrected, in response to the received data. Processor 25 identifies a remaining deficiency in a deficiency chain associated with receipt of the document added to the patient record. Processor 25 updates at least one of, (a) deficiency information in the patient record and (b) the deficiency chain information in the at least one repository, to indicate the identified remaining deficiency in the deficiency chain is associated with the document. The process of FIG. 15 terminates at step 721.

The system, processes and user interface display images presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and process of FIGS. 1 and 6, may be implemented in hardware, software or a combination of both. The invention principles can be extended for use with any workflow related to tracking and addressing document deficiencies. Deficiencies and deficiency chains may be applied to any business object. Deficiency chains in one embodiment are used by a Healthcare Information Management system to implement record completion workflow but may also be used for other workflows related to documents and records in the healthcare or other industries.

What is claimed is:

1. A healthcare document processing system for processing data indicating a document deficiency preventing a document from being designated complete, comprising:
an interface for receiving data including a patient record identifier and data identifying a document, and an associated document type, said document having been added to a patient record having said patient record identifier; and
a document processor for, in response to said received data, automatically,
searching deficiency information associated with said patient record to identify a document deficiency associated with said document of said document type,
indicating a deficiency associated with absence of said document from said patient record is corrected and
determining if a new deficiency is associated with said document and generating associated deficiency data identifying said new deficiency for incorporation in said deficiency information.

2. A system according to claim 1, wherein
said document processor identifies a type of said new deficiency and initiates generation of an alert message to a user indicating user attention is required and
said deficiency type indicates at least one of, (a) how a deficiency is to be corrected and (b) the purpose of the deficiency.

3. A system according to claim 1, wherein
said document processor identifies a type of said new deficiency and initiates generation of an alert message to a user indicating user attention is required

4. A system according to claim 1, including
a task processor for automatically assigning a task to be performed by a healthcare worker in response to said determined new deficiency.

5. A system according to claim 1, including
at least one repository including chain data identifying, a plurality of document deficiencies, individual document deficiency type and an order for addressing said document deficiencies for providing completed documents and
said document processor uses said at least one repository to identify deficiency chain information associated with said document and indicates deficiencies of said deficiency chain associated with absence of said document from said patient record are corrected.

6. A system according to claim 5, wherein
said document processor identifies a remaining deficiency in said deficiency chain associated with receipt of said document into said patient record.

7. A system according to claim 6, wherein
said document processor updates at least one of, (a) deficiency information in said patient record and (b) said deficiency chain information in said at least one repository, to indicate said identified remaining deficiency in said deficiency chain is associated with said document.

8. A healthcare document processing system for processing data indicating a document deficiency preventing a document from being designated complete, comprising:
an interface for receiving data including a patient record identifier and data identifying a document, and an associated document type, said document having been added to a patient record having said patient record identifier;
at least one repository including chain data identifying, a plurality of document deficiencies, individual document deficiency type and an order for addressing said document deficiencies for providing completed documents; and
a document processor for, automatically employing said at least one repository to identify deficiency chain information associated with said document and indicating deficiencies of said deficiency chain associated with absence of said document from said patient record are corrected, in response to said received data.

9. A system according to claim 8, wherein
said document processor updates at least one of, (a) deficiency information in said patient record and (b) said deficiency chain information in said at least one repository, to indicate said deficiencies of said deficiency chain associated with absence of said document from said patient record are corrected.

10. A system according to claim 8, wherein
said document processor,
identifies a remaining deficiency in said deficiency chain associated with receipt of said document into said patient record and
updates at least one of, (a) deficiency information in said patient record and (b) said deficiency chain information in said at least one repository, to indicate said identified remaining deficiency in said deficiency chain is associated with said document.

11. A system according to claim 10, including
a task processor for automatically assigning a task to be performed by a healthcare worker in response to said identified remaining deficiency.

12. A system according to claim 10, wherein
said document processor identifies a type of said identified remaining deficiency and initiates generation of an alert message to a user indicating user attention is required for said identified remaining deficiency.

13. A system according to claim 8, wherein
said document processor,
searches deficiency information associated with said patient record to identify a document deficiency associated with said document of said document type,
indicates a deficiency associated with absence of said document from said patient record is corrected and
determines if a new deficiency is associated with said document and generating associated deficiency data identifying said new deficiency for incorporation in said deficiency information.

14. A system according to claim 8, wherein
said at least one repository associates a document type with an individual deficiency type and with a process to be used in correcting said individual deficiency.

15. A system according to claim 8, wherein
said deficiency chain information comprises data objects.

16. A healthcare document processing system for processing data indicating a document deficiency preventing a document from being designated complete, comprising:
an interface for receiving data including a patient record identifier and data identifying a document, and an associated document type, said document having been added to a patient record having said patient record identifier; and
a document processor for, in response to said received data, automatically,
searching deficiency information associated with said patient record to identify a document deficiency associated with said document of said document type,
indicating a deficiency associated with absence of said document from said patient record is corrected,
determining if a new deficiency is associated with said document and generating associated deficiency data identifying said new deficiency for incorporation in said deficiency information,
identifying a type of said new deficiency, and
initiating a process for correcting said deficiency, said process being determined in response to said identified deficiency type.

17. A method for processing data indicating a document deficiency preventing a document from being designated complete, comprising the activities of:
receiving data including a patient record identifier and data identifying a document, and an associated document type, said document having been added to a patient record having said patient record identifier;
searching deficiency information associated with said patient record to identify a document deficiency associated with said document of said document type;
indicating a deficiency associated with absence of said document from said patient record is corrected; and
determining if a new deficiency is associated with said document and generating associated deficiency data identifying said new deficiency for incorporation in said deficiency information.

18. A method for processing data indicating a document deficiency preventing a document from being designated complete, comprising the activities of:
receiving data including a patient record identifier and data identifying a document, and an associated document type, said document having been added to a patient record having said patient record identifier;
storing chain data identifying, a plurality of document deficiencies, individual document deficiency type and an order for addressing said document deficiencies for providing completed documents; and
automatically employing said at least one repository to identify deficiency chain information associated with said document and indicating deficiencies of said deficiency chain associated with absence of said document from said patient record are corrected, in response to said received data.

19. A method for processing data indicating a document deficiency preventing a document from being designated complete, comprising the activities of:
receiving data including a patient record identifier and data identifying a document, and an associated document type, said document having been added to a patient record having said patient record identifier;
searching deficiency information associated with said patient record to identify a document deficiency associated with said document of said document type,
indicating a deficiency associated with absence of said document from said patient record is corrected;
determining if a new deficiency is associated with said document and generating associated deficiency data identifying said new deficiency for incorporation in said deficiency information;
identifying a type of said new deficiency; and
initiating a process for correcting said deficiency, said process being determined in response to said identified deficiency type.
